(19) United States
(12) Patent Application Publication
(10) Pub. No.: US 2009/0182797 A1
(43) Pub. Date: Jul. 16, 2009

(54) CONSISTENT CONTINGENCY TABLE RELEASE

(75) Inventors: Cynthia Dwork, San Francisco, CA (US); Frank McSherry, San Francisco, CA (US); Kunal Talwar, San Francisco, CA (US); Boaz Barak, New York, NY (US); Kamalika Chaudhuri, San Diego, CA (US); Satyen Kale, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/972,618

(22) Filed: Jan. 10, 2008

(51) Int. Cl. G06F 17/14; G06F 17/30

(52) U.S. Cl. 708/403; 707/102; 707/E17.044

(57) ABSTRACT

Techniques for contingency table release provide an accurate and consistent set of tables while guaranteeing that privacy is preserved. A positive and integral database is constructed that corresponds to these tables. Therefore, a database can be generated that preserves low-order marginals up to a small error. Moreover, a gracefully degrading version of the results is provided as a database can be computed such that the error in the low-order marginals is small, and increases smoothly with the order of the marginal.

### BACKGROUND

Contingency tables are used to record and analyze the relationship between two or more variables and are often used in the reporting of official data and statistics. Privacy, accuracy, and consistency among released tables are critical components of any data analysis system that reports contingency tables. Current techniques for reporting contingency tables do not provide strong guarantees on at least one of privacy, accuracy, and consistency among released tables.

A contingency table may be viewed as a table of counts. From a database consisting of a certain number of rows, each comprising values for a fixed set of binary attributes a₁, . . . , aₖ, a contingency table is the histogram of counts for each of the 2^{k} possible settings of these attributes. The counts for each of the possible settings of a restricted set of attributes are called marginals, with each marginal being associated with a subset of the attributes.

Contingency tables are essentially equivalent to On-Line Analytical Processing (OLAP) cubes, which cast traditional relational databases as a high-dimensional cube with dimensions corresponding to the attributes. OLAP cubes are logically related to contingency tables, and currently have the same lack of strong guarantees regarding privacy, accuracy, and consistency.

### SUMMARY

Techniques for contingency table release provide an accurate and consistent set of tables while guaranteeing that privacy is preserved. A positive and integral database is constructed that corresponds to these tables. Therefore, a database can be generated that preserves low-order marginals up to a small error. Moreover, a gracefully degrading version of the results is provided as a database can be computed such that the error in the low-order marginals is small, and increases smoothly with the order of the marginal.

In an implementation, noise may be introduced to a result to provide privacy while maintaining accuracy. The noise that may be introduced to the result does not introduce inconsistencies among released marginals. Consistency is maintained across multiple independent queries. In this manner, multiple independent queries will lead to consistent results.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an implementation of a system that may be used to provide contingency table release;

FIG. 2 is an operational flow of an implementation of a method of generating a contingency table having marginals that are guaranteed to have privacy, accuracy, and consistency when released;

FIG. 3 is an operational flow of another implementation of a method of generating a contingency table having marginals that are guaranteed to have privacy, accuracy, and consistency when released;

FIG. 4 is an operational flow of another implementation of a method of generating a contingency table having marginals that are guaranteed to have privacy, accuracy, and consistency when released; and

FIG. 5 shows an exemplary computing environment.

### DETAILED DESCRIPTION

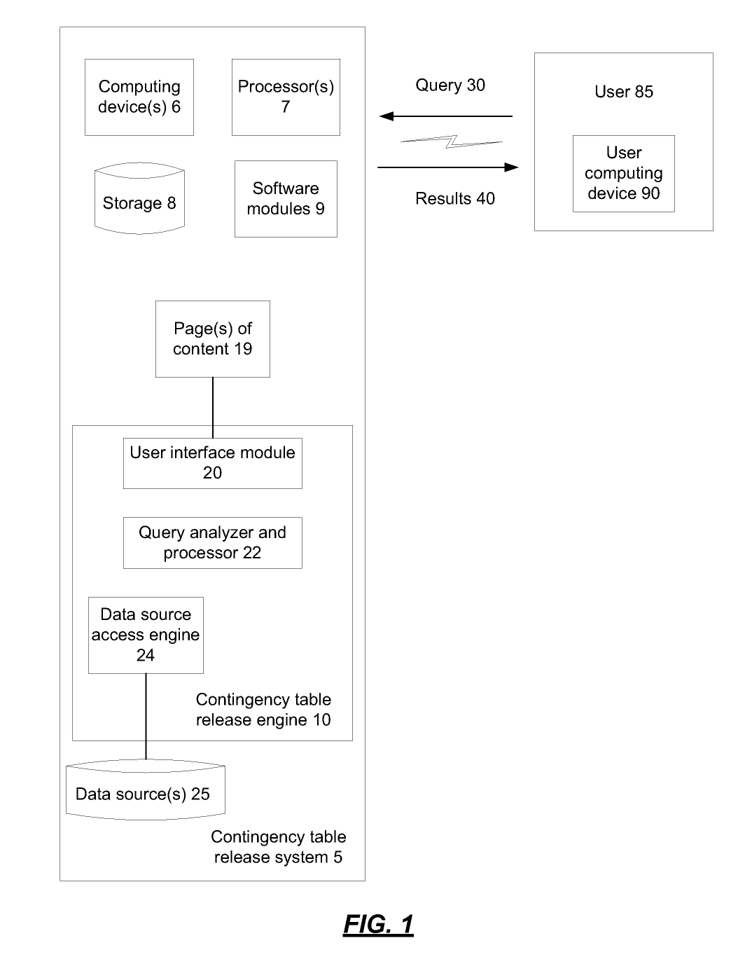

FIG. 1 is a block diagram of an implementation of a system that may be used to provide contingency table release. A contingency table release system 5 may include a contingency table release engine 10. The contingency table release engine 10 may receive a query 30 from a user 85 via a user computing device 90, and may provide results 40, comprising marginals of a contingency table for example, to the user 85 via the user computing device 90. In an implementation, the user computing device 90 may be connected to the contingency table release system 5 by a communications network, for example, such as a local area network, a wide area network, or the Internet.

The contingency table release engine 10 may include a user interface module 20, a query analyzer and processor 22, and a data source access engine 24. The user interface module 20 may generate and format data, such as one or more pages of content 19, as a unified graphical presentation that may be provided to the user computing device 90 as an output from the contingency table release engine 10.

Data used in responding to a query may be retrieved from data source(s) 25. Data source(s) 25 may contain data that may be pertinent to the query, such as personal and/or financial data pertaining to users or a population group, for example. This information may be accessed, retrieved, and used by the contingency table release engine 10. It is contemplated that any number of data sources may be in communication with the contingency table release system 5 and may provide any type of data thereto. The data retrieved from the data source(s) 25 may be stored centrally, perhaps in storage associated with the contingency table release system 5, such as storage 8.

The query analyzer and processor 22 may receive information from the data source(s) 25 via the data source access engine 24. The query analyzer and processor 22 may perform contingency table release techniques described herein and provide results 40 to the user computing device 90.

The contingency table release system 5 may comprise one or more computing devices 6. A user computing device 90 may allow a user 85 to interact with the computing device(s) 6. The computing device(s) 6 may have one or more processors 7, storage 8 (e.g., storage devices, memory, etc.), and software modules 9. The computing device(s) 6, including its processor(s) 7, storage 8, and software modules 9, may be used in the performance of the techniques and operations described herein. Information associated with the user 85 may be stored in storage 8 or other storage such as one or more data sources 25, for example.

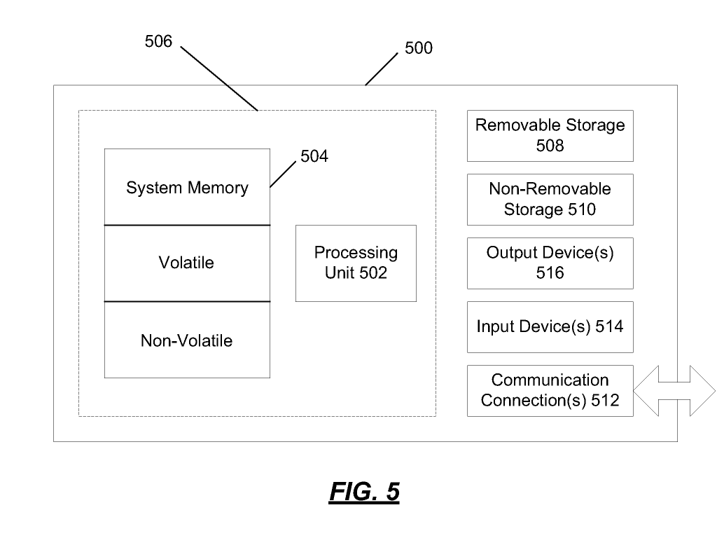

Examples of software modules 9 may include modules for receiving a query, generating Fourier coefficients, maintaining and executing a linear program, generating Laplace noise, and generating and releasing contingency table results, described further herein. While specific functionality is described herein as occurring with respect to specific modules, the functionality may likewise be performed by more, fewer, or other modules. The functionality may be distributed among more than one module. An example computing device and its components are described in more detail with respect to FIG. 5.

As described further herein, noise may be introduced to the result to provide privacy while maintaining accuracy. The noise that may be introduced to the result does not introduce inconsistencies among released contingency tables. Consistency is maintained across multiple independent queries. In this manner, the same query will lead to consistent results.

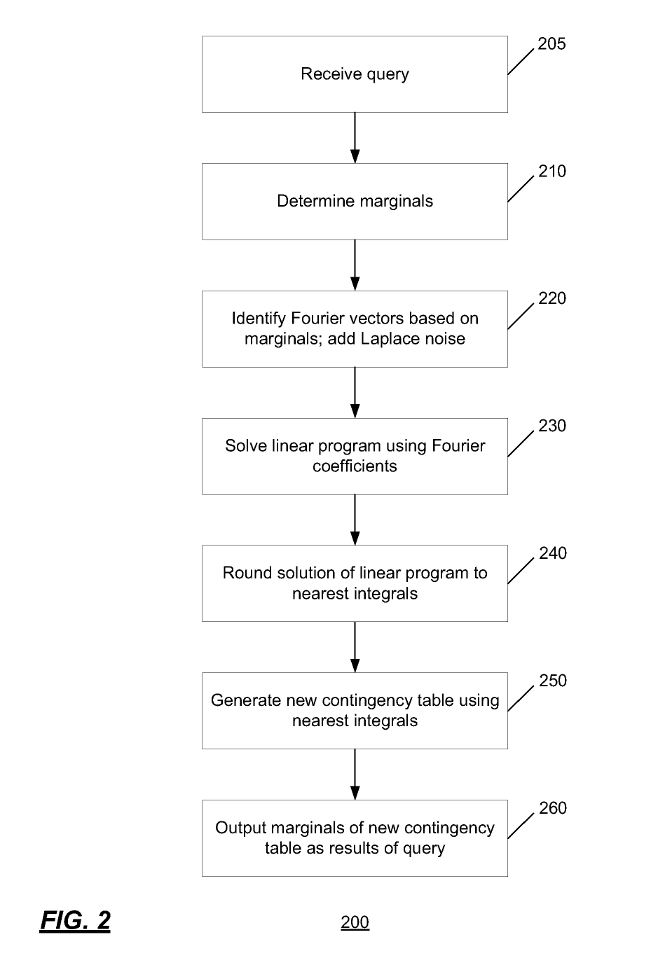

FIG. 2 is an operational flow of an implementation of a method 200 of generating a contingency table having marginals that are guaranteed to have privacy, accuracy, and consistency when released. At operation 205, a query is received. Marginals are determined in response to the query at operation 210, as described further herein. Fourier vectors are determined based on the marginals, and Laplace noise is added at operation 220. A linear program is solved at operation 230 using Fourier coefficients, as described further herein.

At operation 240, rounding to the nearest integrals is performed on the solution to the linear program. A new contingency table is generated using the nearest integrals at operation 250. The marginals of the new contingency table are output as the results of the query at operation 260.

As described further herein, with respect to privacy, the presence or absence of any one data element in a contingency table should not substantially influence the distribution over outcomes of the computation. Differential privacy, a well known form of which is referred to as ε-differential privacy, is enforced by the techniques described herein. A randomized function satisfying differential privacy addresses any concern that a user might have about the use of their data by the institution maintaining or using the computing device and generating or providing the results. In a formal sense, the distribution over outcomes is almost as if the participant had opted out of the data set; no event is made substantially more or less likely by the use of their data. These events may be viewed mathematically, for example as outputs leading to a substantial shift between prior and posterior probabilities, or pragmatically for example, as actual objectionable events such as outputs leading to telemarketing calls or a denial of credit. Differential privacy is agnostic to any auxiliary information an adversary may possess and provides guarantees against arbitrary attacks.

With respect to accuracy, the difference between the reported marginals (i.e., the outputted results) of a contingency table and the true marginals (the measured results of the original data set) of a contingency table should be bounded, preferably independent of the size of the data set that is stored and queried on. In an implementation, C is a set of marginals of a first contingency table, each on at most j attributes. Marginals C′ of a second contingency table (e.g., a positive, integral contingency table) are computed, preserving ε-differential privacy, such that with probability 1-δ for any marginal cεC,

∥c-c′∥₁≦2^{j+3}|C|log(|C|/δ)/ε+|C|.

This result does not depend on the total number of attributes in the data set, nor on the total number of elements in the data set, but rather only on the complexity of the query, in terms of the number and order of the marginals. The error in the marginals falls below statistical error due to sampling. Note that while 2^{j} may be considered to be a large number, it is the number of elements that are reported by each marginal. The error may be improved by using the property that it is the number of marginals requested, |C|, that determines a sufficient amount of noise.

Laplace noise may be added to preserve differential privacy. For example, adding Laplace noise with variance 2σ² to a function f preserves (Δf/σ)-differential privacy. To ensure ε-differential privacy for a query of sensitivity Δ, set σ=Δ/ε. This perturbation approach directly leads to a mechanism for releasing approximations to the marginals of the contingency table. Assume a set of marginals C is to be released. In an implementation, a privacy-preserving approach applies the Laplace noise addition to the |C| marginals (adding noise to each cell in the collection of tables independently), with sensitivity Δf=|C|. This yields ε-differential privacy, which is a very strong guarantee. When n (the number of rows in the database) is large compared to |C| this also yields excellent accuracy. However, there remain small table-to-table inconsistencies caused by independent randomization of each cell in each table, and there may also be negative and non-integer cell counts. With respect to consistency, there should exist a contingency table whose marginals equal the reported marginals, as described further herein.

In an implementation, privacy may be obtained by adding Laplace noise to the raw data or a possibly reversible transformation of the raw data. This gives an intermediate object, which may be operated on further, but there is no longer access to the raw data. Since anything obtained via this technique is privacy-preserving, any quantity computed from the intermediate object is still safe. For example, the privacy-protective intermediate object may be released and the rest of the computations may be carried out. The results would be the same.

In an implementation, the data is transformed into the Fourier domain, which serves as a non-redundant encoding of the information in the marginals. Adding noise in this domain will not violate consistency, because any set of Fourier coefficients corresponds to a (fractional and possibly negative) contingency table. Moreover, very few Fourier coefficients are used to compute low-order marginals, and consequently the magnitude of the noise that is added to them is small.

In an implementation, linear programming may be used to obtain a non-negative, but likely non-integer, contingency table with the given Fourier coefficients, and the results may be rounded to obtain integrality. The marginals obtained from the linear program are no farther from those of the noisy measurements than are the marginals of the raw data. Consequently, the additional error introduced to impose consistency is no more than the error introduced by the privacy mechanism itself. It is not necessary to move to the Fourier domain. The marginals may be perturbed directly, and then linear programming may be used to find a positive fractional data set, which can then be rounded. The accuracy in this case suffers slightly.

In an implementation, the linear program uses time polynomial in 2^{k}, which is the size of the contingency table because that is what the linear program is solving for. When k is large this is not satisfactory. However, non-negativity, but not integrality, can be achieved by adding a relatively small amount to the first Fourier coefficient before moving back to the data domain. No linear program is used, and the error introduced is small. Thus if 2^{k} is too high of a cost and non-integrality is acceptable, then this approach may be used.

Consistent marginals may be created by applying a privacy-preserving mechanism to the Fourier coefficients rather than directly to the marginals. The resulting Fourier coefficients may correspond to a contingency table whose entries are negative and fractional. A linear program is then used which, after rounding, returns a positive integral contingency table, from which marginals may be determined.

With respect to consistency, rather than perturb the marginals, one way of ensuring privacy and consistency is to perturb and release each coordinate of the contingency table. As low-order marginals are sums over many entries in the contingency table, their entries will have noise that is binomially distributed with variance 2^{k}. Alternatively, in an implementation, those features of the data set relevant to the marginal computation, i.e. the Fourier coefficients, are isolated and perturbed. Because substantially fewer measurements are being taken as compared with 2^{k} above, substantially less noise is added to each measurement. For example, only 2ⁱ coefficients are used for an i-way marginal, and only

$${\sum }_{j < i} ( \begin{matrix}k \\ j\end{matrix} )$$

coefficients are used for the full set of i-way marginals. While these numbers may seem large, an i-way marginal releases 2ⁱ counts, making this the natural scale.

The addition of noise may be used to ensure ε-differential privacy. Let Lap(σ) be a random variable with density at γ proportional to exp(−|γ|/σ). The following theorem describes the amount of noise that may be added to each Fourier coefficient, as a function of the number of coefficients to be used: Let A⊂{0,1}^{k} describe a set of Fourier basis vectors, and let x be the contingency table that results from a data set D. Releasing the set φ_{α}=<f^{α}, x>+Lap(2|A|/ε2^{k/2}) for α∈A preserves the ε-differential privacy of D.

While there is a real valued contingency table whose Fourier coefficients equal the perturbed values, e.g., by returning the perturbed values to the original space, it is unlikely that there is a non-negative, integral contingency table with these coefficients. Linear programming may be used to find a non-negative, but likely fractional, contingency table with nearly the correct Fourier coefficients, which may be rounded to an integral contingency table with little additional error.

Letting B⊂{0, 1}^{k}, suppose that Fourier coefficients φ_{β} are observed for β∈ B. The following linear program minimizes, over contingency tables w, the largest error b between its Fourier coefficients <f^{β}, w> and the observed φ_{β}:
minimize b subject to:

$$\begin{matrix}{w}_{α} \geq 0 & ∀ α \\ {Φ}_{β} - {\sum }_{α} {w}_{α} {f}_{α}^{β} \leq b & ∀ β ∈ B \\ {Φ}_{β} - {\sum }_{α} {w}_{α} {f}_{α}^{β} \geq - b & ∀ β ∈ B\end{matrix}$$

This optimization occurs in a 2^{k}+1 dimensional space, and any vertex of the feasible polytope intersects 2^{k}+1 constraints. At most, |B| of these can relate to Fourier coefficients since for each β, only one of the two constraints corresponding to β can intersect any vertex. Thus, at least 2k-|b|+1 are non-negativity constraints. This means that at any vertex of the polytope all but at most |B| weights are zero. Without loss of generality, the linear program will return a vertex solution that may be rounded to the nearest integral point.

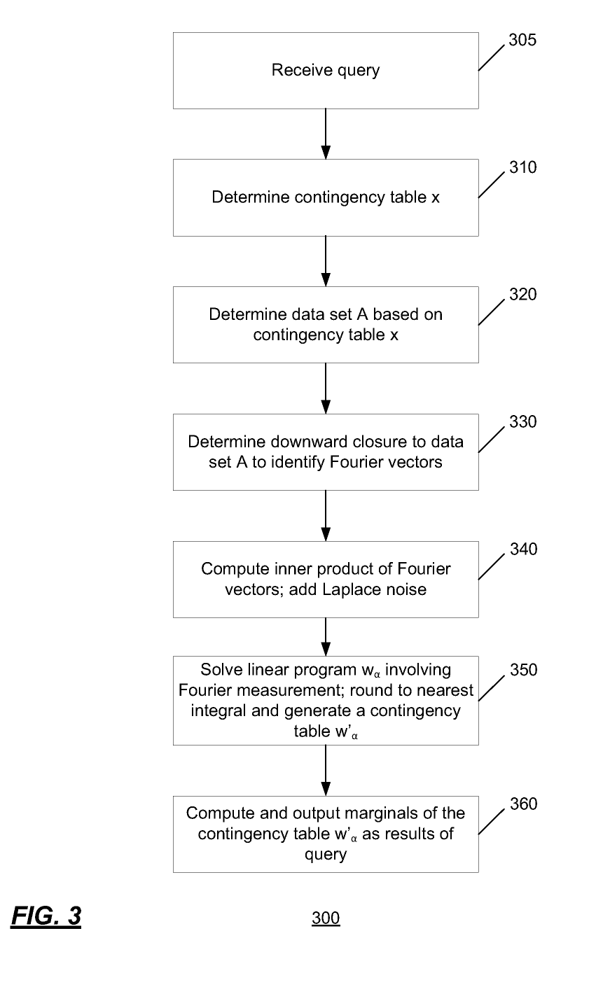

FIG. 3 is an operational flow of another implementation of a method 300 of generating a contingency table having marginals that are guaranteed to have privacy, accuracy, and consistency when released. At operation 305, a query is received. A contingency table x is determined in response to the query at operation 310, and a data set A is determined based on the contingency table x at operation 320. The data set A may be a set of marginals based on the contingency table x.

At operation 330, a downward closure of the data set A is determined. For example, let B be the downward closure of A under [symbol] . Thus, for example, if A is a string of zeros and ones, a subset of ones may be taken and changed to zeros. This downward closure (everything in A that is less than something goes to B) may be used to identify Fourier vectors.

At operation 340, the inner product by of the Fourier vectors is computed to measure the data set x. Laplace noise is added to preserve privacy. For example, for β∈B, compute by φ_{β}=(f^{β}, x)+Lap(2|B|/ε2^{k/2}). In this manner, β may be used to determine the elements of the contingency table x.

At operation 350, a linear program involving a Fourier measurement is solved. For example, in the linear program below, w_{α} is solved for, and rounded to the nearest integral weights w′_{α}. w_{α} is the count of the number of elements in the data set whose attributes are α. w is a collection of values, one for each α string. Rounding to the nearest integral turns a non-negative fractional data set to a non-negative integral data set. wα_{α} is privacy-preserving at this point.

In an implementation, a linear program may be:
minimize b subject to:

$$\begin{matrix}{w}_{α} \geq 0 & ∀ α \\ {Φ}_{β} - {\sum }_{α} {w}_{α} {f}_{α}^{β} \leq b & ∀ β ∈ B \\ {Φ}_{β} - {\sum }_{α} {w}_{α} {f}_{α}^{β} \geq - b & ∀ β ∈ B\end{matrix}$$

The result of this Fourier measurement gets as close as possible to the previously computed B.

At operation 360, using the contingency table w′_{α}, the marginals corresponding to data set A are computed using standard techniques and output. Thus, w′_{α} is treated as the source of data and is the rounded number of elements having attribute α.

Using the notation above, for all δ∈[0, 1] with probability 1-δ, for all α∈A, ∥C^{α}x-C^{α}w′∥₁≦^{∥α∥}^{_{α}}8|B|log(|B|/δ)/ε+|B|. Each Fourier coefficient has Laplace noise with parameter 2|B|/ε2^{k/2} added to it, and with probability 1-δ none of these exceeds 4|B|log (|B|/δ)/ε2^{k/2}. In solving the linear program, the error associated with each Fourier coefficient is at most this bound as well, as the original contingency table x is at least as close.

Consequently, for any marginal C^{α}, the error C^{α}x-C^{α}w′ is a result of the noise in the ≢2^{∥α∥}^{₁} Fourier coefficients that contribute to the table, as well as the rounding error that occurs. Multiplying the number of coefficients 2^{∥α∥}^{₁} by the bound above, and adding the |B| error due to the rounding gives the stated bound.

The features of data that turn into consistency may be identified. If measurements are obtained that are inconsistent, Fourier analysis may be used to separate the result into consistent and inconsistent results. The inconsistent results may then be removed. Thus, Fourier analysis may be used to clean up results while maintaining privacy.

Alternate linear programs may be used to find a data set that matches the results of an original contingency table. The linear program described above minimizes the largest error in any Fourier coefficient. There are other linear programs that one could write, for example linear programs that minimize the total error in Fourier coefficients, minimize the largest error in reported marginals, minimize the total error in the reported marginals, or hybrids thereof.

This flexibility allows a user to address particular accuracy concerns (e.g., per cell accuracy). The perturbed Fourier coefficients can be released, and the specific linear program can be run to arrive at an integral, non-negative solution. Bounds similar to those above can be attained using the same methodology: the noise added perturbs the measurements by some distance in the norm of choice, and the linear program finds a non-negative solution at no greater distance from the perturbed measurements.

In another implementation, non-Fourier linear programming may also be used. The conversion to the Fourier domain described above is performed because the Fourier coefficients exactly describe the information required by the marginals. By measuring exactly what is needed, the least amount of noise possible is added. Instead, in an alternate implementation, noise could be added directly to the true marginals from the original contingency table, producing a set of noisy marginals that preserve privacy but not consistency. A linear program may be applied to these noisy marginals to find a non-negative contingency table with nearest marginals.

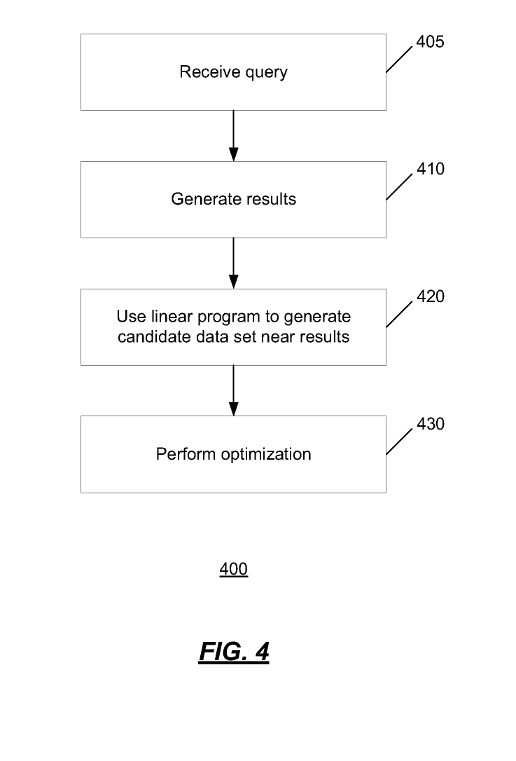

FIG. 4 is an operational flow of another implementation of a method 400 of generating a contingency table having marginals that are guaranteed to have privacy, accuracy, and consistency when released. At operation 405, a query is received. In response, at operation 410, results are provided that are noisy and inconsistent. Using the results and a linear program, at operation 420, a candidate data set is determined that is near to the results. Optimization is then performed, as described herein, at operation 430 to take inconsistent results and turn them into consistent results. Thus, a data set is determined that gives results like the original results and then is optimized.

For example, assuming noisy marginals c^{β} have been observed, a linear program may be:
minimize b subject to:

w_{α}≧0 ∀αε{0,1}^{k}

(c^{β}-C^{β}w)_{γ}≦b ∀βεA,γ≦β

(c^{β}-C^{β}w)_{γ}≧−b ∀βεA,γ≦β

A fractional contingency table w may result, and may be rounded to integers.

In another implementation, a linear program is not used to determine the Fourier coefficients. The Fourier coefficients derived in this implementation correspond to a non-negative, but fractional, contingency table with high probability, without the solution of a linear program. The output marginals are constructed directly from the Fourier coefficients, rather than reconstructing the contingency table, which could take time 2^{k}.

To ensure the existence of a non-negative contingency table with the observed Fourier coefficients, a small amount of noise or perturbation may be added to the first Fourier coefficient. Intuitively, any negativity due to the small perturbation made to the Fourier coefficients is spread uniformly across all elements of the contingency table. Consequently, very little needs to be added to make the elements non-negative.

In another implementation, rather than transforming the data to the Fourier domain, adding noise, and returning it to the data domain, noise may be produced in the Fourier domain and returned to the data domain, where it is directly added to the accurate marginals. In such a case, the transformation is linear, and so, letting F be the Fourier transform, and M be the function that computes marginals from data,

M(F̂-1(F(Data)+Noise))=M(F̂-1(F(Data)))+M(F̂-1(Noise))=M(Data)+M(F̂-1(Noise)).

In an implementation, the noisy consistent marginals may be computed without direct access to the data. The marginals may be non-integral (positivity can be ensured by adding something to the first Fourier coefficient of the noise). The non-integrals can be made into integrals using either with a linear program run against these released marginals or by extracting the Fourier coefficients from the marginals, for example.

Although the implementations described herein are directed to contingency tables, the techniques described herein may also be applied to OLAP cubes.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A contingency table release method, comprising:
determining a first data set based on a first contingency table;
determining a plurality of Fourier coefficients based on the first data set, the Fourier coefficients comprising noise;
solving a linear program based on the Fourier coefficients to generate a solution;
generating a second contingency table based on the solution of the linear program; and
outputting a second data set based on the second contingency table.

2. The method of claim 1, wherein the noise is Laplace noise.

3. The method of claim 1, further comprising receiving a query prior to determining the first data set, wherein the second data set is a result of the query.

4. The method of claim 1, wherein the first data set comprises a plurality of marginals.

5. The method of claim 4, further comprising identifying a plurality of Fourier vectors based on the marginals, wherein determining the Fourier coefficients is based on the Fourier vectors.

6. The method of claim 5, wherein identifying the Fourier vectors comprises determining a downward closure to the marginals.

7. The method of claim 5, further comprising computing an inner product of the Fourier vectors and Laplace noise.

8. The method of claim 4, wherein the second data set comprises a further plurality of marginals.

9. The method of claim 1, further comprising rounding the solution of the linear program to nearest integrals, wherein generating the second contingency table uses the nearest integrals.

10. The method of claim 1, wherein the second data set has the properties of privacy, accuracy, and consistency.

11. A query processing method, comprising:
receiving a query;
generating a first contingency table responsive to the query;
generating a second contingency table responsive to the first contingency table; and
outputting a result to the query based on the second contingency table, the result having the properties of privacy, accuracy, and consistency.

12. The method of claim 11, wherein generating the second contingency table comprises solving a linear program using data based on the first contingency table.

13. The method of claim 12, wherein the data based on the first contingency table comprises a set of noisy marginals.

14. The method of claim 11, wherein generating the second contingency table comprises converting data based on the first contingency table to a Fourier domain and computing the second contingency table in the Fourier domain.

15. The method of claim 11, wherein generating the second contingency table comprises converting a plurality of marginals of the first contingency table to a plurality of Fourier coefficients in a Fourier domain and applying a linear program to the Fourier coefficients.

16. The method of claim 11, wherein the second contingency table is non-negative.

17. A contingency table release system, comprising:
a user interface module that receives a query; and
a query analyzer and processor that generates a first contingency table responsive to the query, generates a second contingency table responsive to the first contingency table, and generates data based on the second contingency table, the data having the properties of privacy, accuracy, and consistency.

18. The system of claim 17, wherein the query analyzer and processor solves a linear program to generate the second contingency table.

19. The system of claim 17, wherein the query analyzer and processor performs a computation on data based on the first contingency table in a Fourier domain.

20. The system of claim 19, wherein the query analyzer and processor uses Laplace noise in the computation on the data based on the first contingency table in the Fourier domain.
